(19) United States
(12) Patent Application Publication
(10) Pub. No.: US 2025/0269552 A2
(43) Pub. Date: Aug. 28, 2025

(54) SYSTEM FOR EXTRUDING BUILDING MATERIAL ENRICHED WITH AGGREGATES AND/OR STEEL FIBRES FOR THE ADDITIVE MANUFACTURING OF ARCHITECTURAL STRUCTURES

(71) Applicant: XTREEE, RUNGIS (FR)

(72) Inventor: Alban MALLET, RUNGIS (FR)

(73) Assignee: XTREEE, RUNGIS (FR)

(21) Appl. No.: 18/691,873

(22) PCT Filed: Sep. 8, 2022
(86) PCT No.: PCT/EP2022/074968

§ 371 Date: Mar. 13, 2024

(30) Foreign Application Priority Data
Sep. 13, 2021 (FR) FR2109558

(51) Int. Cl. B28B 1/00; B28B 1/52; B28B 3/22; B28B 3/24; B33Y 30/00

(52) U.S. Cl. CPC B28B 1/001; B28B 1/523; B28B 3/22; B28B 3/24; B33Y 30/00

(57) ABSTRACT

The invention relates to a system for extrusion of filaments of construction material enriched with aggregates and/or steel fibers, referred to as loaded material, for a robot for additive manufacture of architectural structures comprising: a head (100) for printing filaments of construction material comprising an inlet opening (110) for material and an outlet nozzle (120) for material; a circuit (10) for supplying material to said print head (100) comprising a reservoir (20) for storing loaded material and a conduit (31) for supplying material, connecting said storage reservoir (20) and said print head (100); characterized in that said supply circuit (10) comprises at least one piston pump (40) mounted on said supply conduit (31) and in that said print head (100) comprises an endless screw (150) arranged between said inlet opening (110) and said outlet nozzle (120) and configured to be able to extrude the loaded material in a continuous manner via said outlet nozzle.

### TECHNICAL FIELD OF THE INVENTION

The invention relates to a system for additive manufacture of construction materials comprising aggregates and/or fibers. The invention relates more particularly to a system for extrusion of filaments of construction material comprising aggregates and/or fibers for a robot for additive manufacture of architectural structures.

### TECHNOLOGICAL BACKGROUND

The 3D printing of construction materials is an activity undergoing rapid development, for which the applicant has already proposed numerous innovations to improve the manufacturing processes.

Thus, the application has already proposed, in particular in the applications WO2018/051370, WO2018/229419, WO2019/048752, WO2019/038491 and WO2019/025698, systems for extrusion of filaments of cementitious material for a robot for additive manufacture of architectural structures.

Throughout the text, the phrase “architectural structures” designates both individual construction elements (bridges, pillars, walls, street furniture, etc.), complete structures (buildings, houses, properties, etc.) and various architectural items (works of art, sculptures, etc.).

Throughout the text “aggregate” designates a fragment of rock of a size greater than 3 mm and smaller than 50 mm, intended to be incorporated into the composition of the materials suitable for carrying out public works, civil engineering and building construction.

Throughout the text the phrase “steel fibers” refers to rigid or flexible steel fibers having dimensions of 1 cm to 10 cm in length.

Throughout the text “loaded material” designates a construction material enriched with aggregates and/or steel fibers.

The systems already proposed by the applicant provide numerous advantages over the traditional techniques, including in particular the possibility of being able to produce complex shapes by addition of successive layers of construction materials, the rapidity of the construction operations, the reduction in costs and workforce, improved site safety, etc.

These systems generally comprise a print head equipped with an inlet for construction material and an outlet (or extrusion) nozzle for construction material, a circuit for supplying the print head with construction material, comprising a reservoir for storing construction material, a conduit connecting the storage reservoir and the inlet of the print head, and a pump for boosting the conduit with the construction material from the storage reservoir.

One of the difficulties of the 3D printing of construction materials is found in the fact that the material must be supplied in a rheological state compatible with pumping of this material, i.e. sufficiently fluid to be able to be pumped from the storage reservoir and fed toward the outlet nozzle, while its state must be viscous enough (i.e. less fluid) downstream of the outlet nozzle to be able to form a self-supporting layer able to support the following layer.

Another difficulty is that of maintaining a uniform flow rate for the material, making it possible to extrude uniform layers of construction material and thus to form architectural structures with identical properties in each layer and within a single layer.

The current techniques do not make it possible to extrude materials enriched with aggregates and/or steel fibers because they damage the equipment of the printing systems, in particular the equipment linked to the conveying of the construction material between the storage reservoir and the print head. For example, the materials enriched with steel fibers prick the members of the printing systems, and in particular the metering pumps, which prevents use thereof with the current systems.

Therefore, it is not possible to use the known systems to extrude materials loaded with aggregates over long distances, i.e. to feed the construction material from a storage reservoir to the extrusion head over long distances, in particular distances of the order of about ten meters, because such a material does not have a rheology compatible with the pumping means used in the system, in particular pumps with an eccentric screw, which are generally used to feed the cementitious material toward the extrusion head while minimizing pulsing.

It is thus not currently possible to use materials enriched with aggregates and/or steel fibers in 3D extrusion systems. The only option consists of adding aggregates and/or steel fibers directly at the print head, just before the extrusion, but the need for a homogeneous mix associated the problems of conveying aggregates and/or fibers makes introduction of these components at the end very difficult or even impossible to achieve.

The inventors have thus sought to adapt the systems already proposed in order to enable their use with materials loaded with aggregates with a view to reducing the shrinkage, the cracking, the ecological footprint and the cost of the construction material dedicated to the additive manufacture of complex architectural structures.

The inventors have also sought to adapt the systems already proposed in order to enable use thereof with materials loaded with steel fibers with a view to improving the resistance to bending and the ductility of the architectural structures manufactured with such a material.

### AIMS OF THE INVENTION

The invention thus aims to provide a system for extrusion of construction material enriched with aggregates and/or steel fibers, referred to as loaded material.

The invention also aims to provide, in at least one embodiment, such a system, which makes it possible to convey the loaded material over a long distance, in particular over a distance of about ten meters.

The invention also aims to provide, in at least one embodiment, such a system which makes possible a uniformity in the extrusion of the loaded material.

The invention also aims to provide, in at least one embodiment, such a system which makes it possible to extrude loaded construction material in a continuous manner.

The invention also aims to provide, in at least one embodiment, such a system which makes it possible to extrude the loaded material at a high flow rate.

Finally, the invention aims to provide, in at least one embodiment, such a system which makes it possible to reduce the shrinkage, the cracking, the ecological footprint and/or the cost of the construction material used to manufacture a complex architectural structure.

Finally, the invention aims to provide, in at least one embodiment, such a system which makes it possible to improve the resistance to bending and the ductility of the architectural structures manufactured.

### DESCRIPTION OF THE INVENTION

In order to do this, the invention relates to a system for extrusion of filaments of construction material enriched with rock fragments, of a size greater than 3 mm and less than 50 mm, referred to as aggregates, and/or rigid or flexible steel fibers having dimensions of 1 cm to 10 cm in length, referred to as loaded material, for a robot for additive manufacture of architectural structures comprising:
a head for printing filaments of construction material comprising a material inlet opening and an outlet nozzle configured to form filaments of material, said print head being intended to be moved by the additive manufacturing robot along a predetermined path in order to form an architectural structure by stacking layers of said extruded filaments,
a circuit for supplying material to said print head, comprising a reservoir for storing loaded material and a material supply conduit connecting said storage reservoir and said print head.

The extrusion system in accordance with the invention is characterized in that said supply circuit comprises at least one piston pump mounted on said supply conduit and configured to enable the loaded material to be conveyed from the storage reservoir to said print head without controlled adjustment of the flow rate.

The extrusion system in accordance with the invention is also characterized in that said print head comprises an endless screw arranged between said inlet opening and said outlet nozzle and configured to be able to extrude the loaded material in a continuous manner via said outlet nozzle.

The system in accordance with the invention thus makes it possible, by the combination of at least one piston pump intended for conveying the loaded construction material within the supply circuit and of an endless screw intended for the extrusion of the loaded material within the print head (also referred to by the phrase “extrusion head” in the text), to convey the loaded material over long distances without any particular flow rate constraints, and to extrude the loaded material in a continuous manner by the presence of an endless screw housed in the print head upstream of the extrusion nozzle.

In other words, the invention is remarkable in that the conveying and the extrusion of the material are split into two sub-assemblies which are distinct but which cooperate with each other to make possible the conveying and the extrusion of a material enriched with aggregates and/or steel fibers.

The system in accordance with the invention thus makes it possible to bypass the limitations of the prior art, which made it necessary to adapt the rheology and the composition of the material to the constraints of conveyance and directly to control the metering of the material by metering pumps with an eccentric screw within the supply circuit, which were incompatible with a loaded material. For loaded materials, the only solution available was to add the aggregates directly into the print head, without being able to feed the material through a supply circuit, in particular over long distances. In the invention, the depositing of the material is controlled directly in the extrusion head by an endless screw and the conveying of the loaded material over a long distance and at a high flow rate is enabled by the use of a piston pump.

In accordance with the invention, the piston pump used can be of any known type. It may be an axial piston pump, a radial piston pump, etc.

One or a plurality of piston pumps can be used depending on the length of the supply conduit fluidically connecting the storage reservoir and the extrusion head.

A system in accordance with the invention thus makes it possible, in the case of a material enriched with aggregates, to reduce the shrinkage, the cracking, the ecological footprint and the cost of the construction material used to manufacture an architectural structure.

A system in accordance with the invention also makes it possible, in the case of a material enriched with steel fibers, to increase the resistance to bending and the ductility of the architectural structures manufactured.

Advantageously and in accordance with the invention, said storage reservoir comprises means for mixing a plurality of components in order to be able to form said loaded material.

According to this variant, the storage reservoir also forms the reservoir in which the material enriched with aggregates and/or steel fibers is formed. In order to do this, the reservoir comprises means for mixing a plurality of materials or components being incorporated into the composition of the loaded construction material. These components are chosen, for example from the list comprising water, additives, steel fibers, aggregates, sand, hydraulic binders and geopolymers. The mixing means are formed, for example, by a motorized shaft extending longitudinally in the reservoir and bearing lateral blades making it possible to mix components by causing the shaft bearing the blades to rotate.

According to another variant of the invention, the system comprises a reservoir dedicated to the mixing and linked fluidically to the storage reservoir. In this variant, the mixing means mentioned above are housed in the reservoir dedicated to the mixing, and the mixed material is fed toward the storage reservoir, for example by gravity.

Advantageously and in accordance with the invention, the storage reservoir further comprises agitating means of the reservoir in order to enable the loaded material to be formed into a state compatible with the conveying thereof via said supply conduit.

According to this variant, the storage reservoir comprises, for example, a conical hopper fluidically connected, on the one hand, to the mixing reservoir (in the case where the system is equipped with such a dedicated reservoir) in order to be able to receive the mixed loaded material and, on the other hand, to the supply conduit of the print head in order to be able to supply the conduit with construction material. The storage reservoir is preferably equipped with agitating means of the reservoir, making it possible to put the material into a state compatible with pumping toward the supply conduit. In combination, the reservoir is preferably equipped with means for pushing material toward the supply conduit, which makes it possible in particular to push the non-self-consolidating materials into the supply conduit. These pushing means are formed, for example, by blades borne by a motorized shaft and oriented so as to be able to animate the material toward the supply conduit.

Advantageously and in accordance with the invention, said print head further comprises a retention tank arranged between the inlet opening and the endless screw and equipped with agitating and/or pushing and/or vibrating means of said tank in order to facilitate the extrusion of the loaded material by said endless screw.

According to this variant, the print head comprises a retention tank into which the supply conduit of the supply circuit issues via the inlet opening. This tank is provided, for example, with a mixing rod which extends longitudinally between the inlet opening and the endless screw. This mixing rod is provided, for example, with lateral blades making it possible to agitate the material before its extrusion by the endless screw. According to one variant, the mixing rod and the endless screw share the same mechanical shaft, caused to rotate by motorized means. According to one variant, the blades are also oriented toward the endless screw so to as be able to animate the material toward the endless screw.

The invention also relates to a robot for additive manufacture of architectural structures comprising a positioning system, such as an articulated arm or a gantry, controlled by a control unit, and an extrusion system in accordance with the invention comprising an extrusion head mounted on said positioning system so that the movement of the positioning system bearing said print head along a predetermined path makes possible the manufacture of an architectural structure by stacking layers of filaments of cementitious material.

The advantages and effects of an extrusion system in accordance with the invention apply mutatis mutandis to a robot for additive manufacture in accordance with the invention.

The invention also relates to a method for extrusion of filaments of construction material enriched with rock fragments, of a size greater than 3mm and less than 50 mm, referred to as aggregates, and/or rigid or flexible steel fibers having dimensions of 1 cm to 10 cm in length, referred to as loaded material, for a robot for additive manufacture of architectural structures, said method comprising:
a step of supplying loaded material to a head for printing filaments of construction material,
a step of extrusion of filaments of loaded material via a print head comprising an inlet opening for material and an outlet nozzle configured to form filaments of loaded construction material.

The method in accordance with the invention is characterized in that:
said supply step comprises the conveying of the loaded material within a supply conduit fluidically connected between a reservoir for storing loaded material and said print head by action of at least one piston pump configured to enable the loaded material to be conveyed without controlled adjustment of the flow rate,
said extrusion step comprises the movement of the loaded material within the print head toward the outlet nozzle by action of an endless screw arranged between said inlet opening and said outlet nozzle and configured to be able to extrude the loaded material in a continuous manner via said outlet nozzle.

A method in accordance with the invention is advantageously implemented by an extrusion system in accordance with the invention and an extrusion system in accordance with the invention advantageously implements a method in accordance with the invention.

Advantageously, the method in accordance with the invention further comprises a step of mixing a plurality of components in order to form said loaded material.

This mixing step is preferably implemented by the mixing means housed in the storage reservoir of the extrusion system in accordance with the invention or in a dedicated mixing reservoir arranged fluidically upstream of the storage reservoir of the extrusion system in accordance with the invention.

Advantageously, the method in accordance with the invention further comprises a step of agitating the material before it is conveyed via said supply conduit.

This agitating step is preferably implemented by the agitating means housed in the storage reservoir of the extrusion system in accordance with the invention.

Advantageously, the method in accordance with the invention further comprises a step of pushing the material toward said supply conduit.

This step is preferably implemented by the means for pushing the material, which are housed in the storage reservoir of the extrusion system in accordance with the invention.

Advantageously, the method in accordance with the invention further comprises a step of agitating the material in a retention tank arranged between the inlet opening and the endless screw of said print head in order to facilitate the extrusion of the loaded material by said endless screw.

The invention also relates to an extrusion system, an additive manufacturing robot and an extrusion method, which are characterized in combination by all or some of the features mentioned above or below.

### LIST OF FIGURES

Other aims, features and advantages of the invention will become apparent upon reading the following description given solely in a non-limiting way and which makes reference to the attached figures in which:

FIG. 1 is a schematic view of an extrusion system in accordance with one embodiment of the invention,

FIG. 2 is a schematic view of an additive manufacturing robot in accordance with one embodiment of the invention,

FIG. 3 is a schematic view of an extrusion method in accordance with one embodiment of the invention,

FIG. 4 is a schematic view of a storage reservoir in accordance with one embodiment of the invention, formed by the combination of a mixing reservoir and an agitating reservoir.

### DETAILED DESCRIPTION OF AN EMBODIMENT OF THE INVENTION

In the figures, for the purposes of illustration and clarity, scales and proportions have not been strictly respected. Throughout the detailed description which follows with reference to the figures, unless stated to the contrary, each element of the extrusion system is described as it is arranged when the extrusion system is used within the scope of the manufacture of an architectural structure by stacking layers of extruded filaments.

Furthermore, identical, similar or analogous elements are designated by the same reference signs in all the figures.

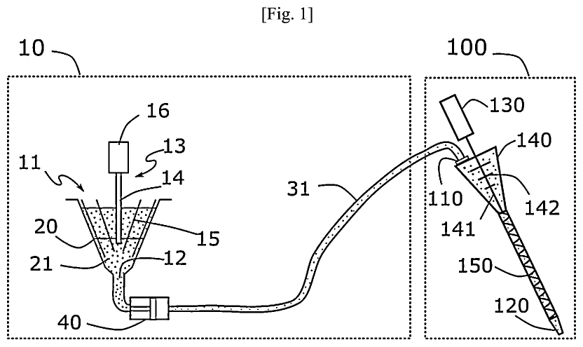

An extrusion system in accordance with the invention comprises, as shown in FIG. 1, two main sub-systems: a head 100 for printing filaments of construction material and a circuit 10 for supplying the print head 100 with material enriched with aggregates and/or steel fibers 21.

The two sub-systems will be described in detail later in the text.

### Supply Circuit

The supply circuit 10 comprises a reservoir 20 for storing a construction material enriched with aggregates and/or steel fibers 21, a conduit 31 connecting an outlet 12 of the storage reservoir 20 to an inlet opening 110 of the print head 100, and a piston pump 40 arranged on the conduit 31 in order to enable the loaded material to be conveyed in the conduit 31 without controlled adjustment of the material flow rate. This piston pump 40 is, for example, a pump marketed by the company Putzmeister® under the reference KOS. Of course, other types of piston pump can be used and/or tested by a person skilled in the art for implementation of the system in accordance with the invention.

The piston pump 40 makes it possible to convey the loaded construction material over a long distance, in a continuous manner and without needing to adjust the uniformity of the flow rate. The uniformity of the material is managed at the print head 100 by means of the endless screw described below.

The storage reservoir 20 is preferably a hopper comprising an upper opening 11 adapted to receive batches of cementitious materials enriched with aggregates and/or steel fibers 21 and a lower outlet 12 connected to the conduit 31. The hopper can further comprise a mixer 13 comprising a shaft 14 bearing a plurality of lateral blades 15 and possibly a scraper, and a motor 16 for causing the shaft 14 to rotate. The motor 16 is, for example, an electric motor configured to be able to drive the shaft 14 of the mixer 13 at low speed, for example at a speed of 6 to 20 revolutions per minute. Of course, it is possible to use a heat engine without modifying the performance of the extrusion system in accordance with the invention. This mixer 13 can also form means for mixing a plurality of components being incorporated into the composition of the construction material enriched with aggregates and/or steel fibers. These components are chosen, for example from the group comprising water, additives, aggregates, steel fibers, sand, hydraulic binders and geopolymers.

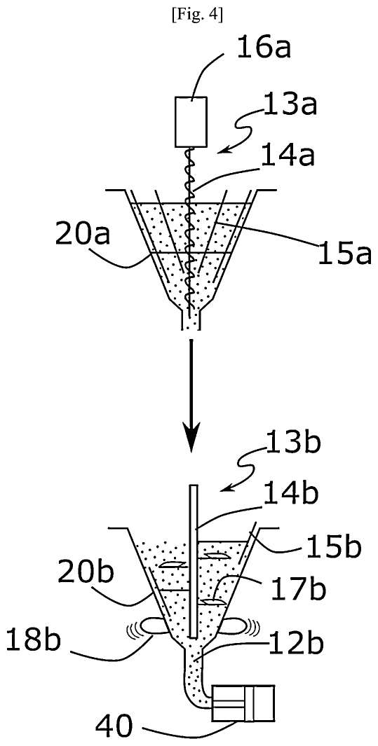

The storage reservoir can also comprise agitating means of the hopper, which can be of any known type such as, for example, those described in relation to FIG. 4.

FIG. 4 illustrates a particular embodiment of the system upstream of the supply conduit which is formed by a reservoir 20a dedicated to mixing and by a reservoir 20b dedicated to agitating and pushing the material toward the supply conduit. In other words, this embodiment of FIG. 4 separates the mixing function and the agitating and pushing function of the storage reservoir 20 of the embodiment of FIG. 1.

According to the embodiment of FIG. 4, the reservoir 20a receives a plurality of components being incorporated into the composition of the construction material enriched with aggregates and/or steel fibers. A mixer 13a formed by an electric motor 16a, a central mixer 14a and a plurality of blades 15a forming lateral mixing means ensures that the different components are mixed. The loaded material thus formed is then conducted by the natural force of gravity into the reservoir 20b.

The reservoir 20b comprises a central shaft 14b driven in rotation by an electric motor, not shown in FIG. 4 for the sake of clarity, and which bears, on the one hand, scrapers 15b intended to scrape the walls of the reservoir and, on the other hand, pushing blades 17b oriented toward the outlet 12b of the reservoir and intended to push the material toward the piston pump 40 fluidically connected to the outlet 12b. The reservoir 20b also comprises a vibrator 18b forming the agitating means of the reservoir. This vibrator is formed, for example, by a pneumatic or electric vibrator mounted on the reservoir by means of a fixing cradle. There may also be vibration rods or any equivalent means immersed in the reservoir or mounted on the reservoir.

### Print Head 100

The print head 100 comprises, as shown schematically by FIG. 1, an inlet opening 110 connected to the conduit 31 of the supply circuit 10 and an outlet nozzle 120 configured to form filaments of cementitious material.

The print head 100 further comprises an endless screw 150 driven in rotation by a motor 130 and configured to be able to drive the loaded construction material toward the outlet nozzle 120.

The print head 100 also comprises a retention tank 140 arranged between the inlet opening 110 and the endless screw 150. This retention tank 140 comprises a shaft 141 which extends longitudinally in the retention tank 140 and which is driven in rotation by the motor 130. This shaft 141 is further equipped with radial fingers 142 configured to be able to agitate and/or push the construction material, and thus forming means for agitating and pushing the material prior to extrusion by the endless screw 150.

The motor 130 can be an electric motor, a heat engine, and generally any type of motor.

The outlet nozzle 120 of the print head 100 is preferably detachable so that it is possible to adapt the shape of the outlet nozzle 120 to the piece to be manufactured. In particular, the cross-section of the outlet 120 can be adapted to each type of piece manufactured, or even changed during printing in order to modify the cross-section of the filaments of certain portions of the piece manufactured. In order to do this, the outlet nozzle comprises, for example a threaded external wall which cooperates with a threaded internal portion of the wall of the print head in which the endless screw 150 extends. In another variant, the outlet nozzle comprises a threaded internal wall which cooperates with an external threaded portion of the wall of the print head.

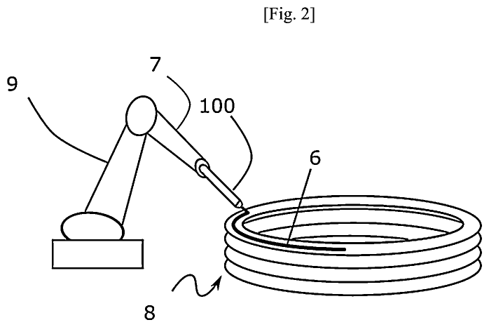

FIG. 2 is a schematic view of a robot 9 for additive manufacture of an architectural structure 8 in accordance with one embodiment of the invention. Such a robot 9 comprises an articulated arm or gantry 7 controlled by a control unit, not shown in the figure, which bears the print head 100 of an extrusion system in accordance with the invention.

For reasons of clarity, FIG. 2 shows only the print head 100, it being understood that this print head is supplied with cementitious material enriched with aggregates and/or steel fibers by a supply circuit 10 as described in relation to FIG. 1.

The robot 9 is controlled by a control unit in order to drive the movement of the print head 100 along a predetermined path making it possible to manufacture the architectural structure 8 by stacking layers of extruded filaments 6. The filament 6 during extrusion is represented schematically by a thick black line.

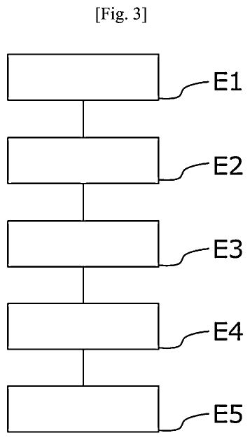

FIG. 3 schematically illustrates the various steps of a method of extrusion in accordance with one embodiment of the invention.

Such a method comprises a first step E1 of forming a construction material enriched with aggregates and/or steel fibers. This step consists, for example, of continuously or discontinuously mixing components selected from the group comprising water, additives, aggregates, steel fibers, sand, hydraulic binders and geopolymers. The composition manufactured depends on the architectural structure to be built and the features of this architectural structure. A person skilled in the art is able to determine the composition suitable for his extrusion project.

The method comprises a second step E2 of filling a reservoir for storing the construction material enriched with aggregates and/or steel fibers.

The method comprises a subsequent step E3 of activating a piston pump in order to supply a conduit fluidically connecting the storage reservoir and a print head borne by an articulated arm of a robot.

The method comprises a step E4 of starting up an endless screw housed in the print head in order to enable the extrusion of the construction material via the outlet nozzle of the print head. This step may comprise a sub-step of supplying a retention tank housed in the print head and agitating the material contained in this retention tank in order to facilitate the extrusion of the loaded material by said endless screw.

The method comprises a concomitant step E5 of moving the articulated arm bearing the print head in order to enable the manufacture of an architectural structure by stacking extruded filaments of construction material.

A method in accordance with the invention is preferably implemented by an extrusion system in accordance with the invention and a robot in accordance with the invention.

The invention is not limited to the described embodiments alone. In particular, according to other embodiments, the robot can be a six-axis robot, which may or may not be mounted on rails or on a gantry. The robot may also be a wire robot or any type of robot which has a positioning system, such as an articulated arm, which can be controlled by computer.

A robot in accordance with the invention can be used to manufacture all types of architectural pieces. Such an architectural piece can be a reinforcing piece, a building and, generally speaking, any piece made of cementitious material. The architectural pieces manufactured by the use of an extrusion system in accordance with the invention can be of varied scales. A portion of a post, a whole post, a wall, a slab element, a building, an item of street furniture, a sculpture, etc. may be made.

1. A system for extrusion of filaments of construction material enriched with rock fragments, of a size greater than 3 mm and less than 50 mm, referred to as aggregates, and/or rigid or flexible steel fibers having dimensions of 1 cm to 10 cm in length, referred to as loaded material, for a robot for additive manufacture of architectural structures comprising:
a head for printing filaments of construction material comprising a material inlet opening and an outlet nozzle configured to form filaments of material, said print head being intended to be moved by the additive manufacturing robot along a predetermined path in order to form an architectural structure by stacking layers of said extruded filaments,
a circuit for supplying said print head with loaded material, comprising a reservoir for storing loaded material and a material supply conduit connecting said storage reservoir and said print head, characterized in that:
said supply circuit comprises at least one piston pump mounted on said supply conduit and configured to enable the loaded material to be conveyed from the storage reservoir to said print head without controlled adjustment of the flow rate,
said print head comprises an endless screw arranged between said inlet opening and said outlet nozzle and configured to be able to extrude the loaded material in a continuous manner via said outlet nozzle.

2. The system as claimed in claim 1, wherein said storage reservoir comprises means for mixing a plurality of components in order to be able to form said loaded material.

3. The system as claimed in claim 1 wherein said storage reservoir further comprises agitating means of said reservoir in order to enable the loaded material to be formed into a state compatible with the conveying thereof via said supply conduit.

4. The system as claimed in claim 1 wherein said print head further comprises a retention tank arranged between the inlet opening and the endless screw and equipped with agitating and/or vibrating and/or pushing means of said tank in order to facilitate the extrusion of the loaded material by said endless screw.

5. A robot for additive manufacture of architectural structures comprising:
a positioning system, such as an articulated arm, controlled by a control unit, and
an extrusion system comprising:
a print head for printing filaments of construction material comprising a material inlet opening and an outlet nozzle configured to form filaments of material, said print head being intended to be moved by the robot along a predetermined path in order to form an architectural structure by stacking layers of said filaments,
a circuit for supplying said print head with loaded material, comprising a reservoir for storing loaded material and a material supply conduit connecting said storage reservoir and said print head,
wherein said supply circuit comprises at least one piston pump mounted on said supply conduit and configured to enable the loaded material to be conveyed from the storage reservoir to said print head without controlled adjustment of the flow rate,
wherein said print head comprises an endless screw arranged between said inlet opening and said outlet nozzle and configured to be able to extrude the loaded material in a continuous manner via said outlet nozzle.

6. A method for extrusion of filaments of construction material enriched with rock fragments, of a size greater than 3 mm and less than 50 mm, referred to as aggregates, and/or rigid or flexible steel fibers having dimensions of 1 cm to 10 cm in length, referred to as loaded material, for a robot for additive manufacture of architectural structures, said method comprising:
a step of supplying loaded material to a head for printing filaments of construction material,
a step of extrusion of filaments of loaded material via a print head comprising an inlet opening for material and an outlet nozzle configured to form filaments of loaded construction material, wherein:
said supply step comprises conveying the loaded material within a supply conduit fluidically connected between a reservoir for storing loaded material and said print head by action of a piston pump configured to enable the loaded material to be conveyed without controlled adjustment of the flow rate,
said extrusion step comprises the movement of the loaded material within the print head toward the outlet nozzle by action of an endless screw arranged between said inlet opening and said outlet nozzle and configured to be able to extrude the loaded material in a continuous manner via said outlet nozzle.

7. The method as claimed in claim 6, further comprising a step of mixing a plurality of components in order to be able to form said loaded material.

8. The method as claimed in claim 6 further comprising a step of agitating the material before it is conveyed via said supply conduit.

9. The method as claimed in claim 6 further comprising a step of pushing the material toward said supply conduit.

10. The method as claimed in claim 6 further comprising a step of agitating the material in a retention tank arranged between the inlet opening and the endless screw of said print head in order to facilitate the extrusion of the loaded material by said endless screw.
